(19) United States
(12) Patent Application Publication
(10) Pub. No.: US 2006/0211407 A1
(43) Pub. Date: Sep. 21, 2006

(54) Method for improving security of mobile communication device

(75) Inventors: Cheng-Shing Lai, Taipei (TW); Rong Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/372,107

(22) Filed: Mar. 10, 2006

(30) Foreign Application Priority Data
Mar. 16, 2005 (TW) 094108102

(51) Int. Cl. H04M 3/16

(52) U.S. Cl. 455/410; 455/411

(57) ABSTRACT

The present invention provides a method for improving security of a mobile communication device comprising the steps of causing the mobile communication device to be either activated or inactivated, determining whether the mobile communication device is activated or not, the mobile communication device being capable of performing certain functions if the mobile communication device is activated, and causing the mobile communication device to be incapable of performing certain functions until the mobile communication device is activated by an external device performing an activation process, thereafter the mobile communication device being capable of performing the functions again if the mobile communication device is not activated.

### FIELD OF THE INVENTION

The present invention relates to a method for improving the security of a mobile communication device and more particularly to a method of improving the security for a mobile communication device by utilizing a one-to-one corresponding relationship between a device identification code of the mobile communication device and an activation code of an external charging device.

### BACKGROUND OF THE INVENTION

Nowadays, mobile communication devices (e.g., mobile phones) have become a ubiquitous tool for personal communication. Conventionally, the most common technique of improving security of a mobile phone for an ordinary user is to set a password for a SIM (Subscriber Identity Module) card or a mobile phone such that another unauthorized person may not be able to use the lost or stolen mobile phone. However, in fact, it is often that a mobile phone user may not set a password for the purpose of convenience, or merely set a simple combination of small number of numerals as the password to prevent from forgetting the password set in the mobile communication device. Thus, the security strength of many mobile communication devices is not satisfactory. Desirably, a mobile phone should be constructed to have sufficient security to virtually eliminate the ability of any unauthorized person to decrypt the password set in the mobile phone and use the mobile phone if it is stolen. Hopefully, the desired mobile phone is also capable of greatly reducing its theft potential so as to achieve the purpose of preventing a mobile phone from being stolen. Thus, it is desirable to provide a novel method for improving the security of a mobile communication device in order to overcome the inadequacies of the prior art.

### SUMMARY OF THE INVENTION

After considerable research and experimentation, a method for improving security of a mobile communication device according to the present invention has been devised so as to overcome the above drawbacks of the prior art. The security improvement is realized by utilizing a one-to-one corresponding relationship between a device identification code of the mobile communication device and an activation code of an external charging device.

It is an object of the present invention to provide a method for improving security of a mobile communication device comprising the steps of causing the mobile communication device to be either activated or inactivated, determining whether the mobile communication device is activated or not, the mobile communication device being capable of performing certain functions if the mobile communication device is activated and causing the mobile communication device to be incapable of performing the functions until the mobile communication device is activated by an external device performing an activation process, thereafter the mobile communication device being capable of performing the functions again if the mobile communication device is not activated.

In one aspect of the present invention the activation process comprises obtaining an activation code from the external device to be checked by a verification process, activating the mobile communication device if the activation code is verified, and remaining the mobile communication device not to be activated if the activation code is not verified.

In another aspect of the present invention the external device is a charging device.

In yet another aspect of the present invention that charging the mobile communication device by the charging device is denied if the activation code from the charging device is incorrect.

In order to achieve the above and other objects, the present invention provides a method for improving security of a mobile communication device wherein the security improvement is realized by utilizing a one-to-one corresponding relationship between a device identification code of the mobile communication device and an activation code of an external charging device and verifying the activation code of the charging device prior to either permitting or not permitting the charging device to charge the mobile communication device. By controlling the activation status of hardware, it is capable of greatly reducing its theft potential so as to achieve the purpose of preventing a mobile communication device from being stolen.

The above and other objects, features and advantages of the present invention will become apparent from the following detailed description taken with the accompanying drawings.

### BRIEF DESCRIPTION OF THE DRAWINGS

FIG. 1 is a flowchart depicting a method for improving security of a mobile communication device according to a preferred embodiment of the invention where a process for determining whether the mobile communication device is activated or not is illustrated;

FIG. 2 is a flowchart depicting a method for improving security of a mobile communication device according to a preferred embodiment of the invention where a verification process is illustrated;

FIG. 3 is a flowchart depicting a method for improving security of a mobile communication device according to a preferred embodiment of the invention where an activation and charging process is illustrated;

FIG. 4 is a block diagram showing the connection between a prior mobile communication device and a charging device; and

FIG. 5 is a block diagram of a mobile communication device incorporating a security-improving mechanism according to another preferred embodiment of the invention which shows the connection between the mobile communication device and the corresponding charging device.

### DETAILED DESCRIPTION OF THE PREFERRED EMBODIMENTS

Referring to the drawings, the invention is directed to a method for improving the security of a mobile communication device wherein the same numerals indicate the same elements throughout the drawings.

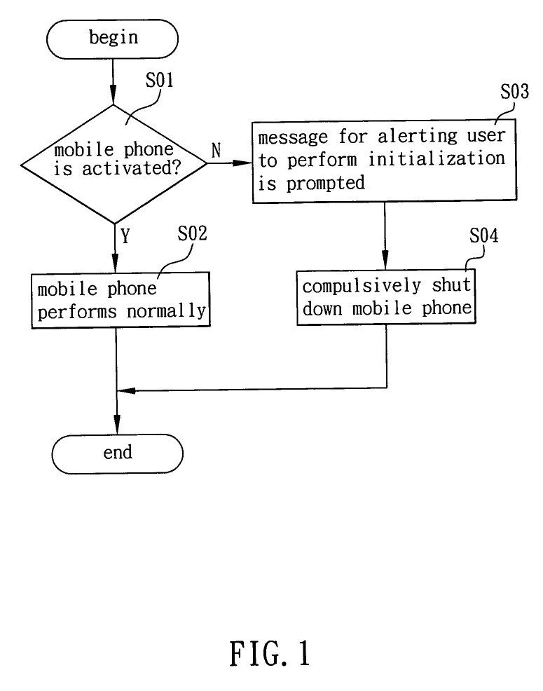

Referring to FIG. 1, the method for improving the security of a mobile communication device (e.g., mobile phone) with a feature that the mobile communication device is either activated or inactivated is illustrated. The preferred embodiment of the invention shows process for determining whether the mobile communication device is activated. The process comprises the following steps.

In the step S01, determining whether the mobile communication device is activated or not is performed. If the mobile communication device is activated, the mobile communication device is capable of performing certain functions S02; otherwise a message for alerting a user to perform an initialization is prompted S03 and then the mobile communication device is compulsively shut down S04.

The above-mentioned mobile communication device is not always activated. If the mobile communication device is activated over some duration, the mobile communication device is then inactivated. For example, if a mobile phone is set to be activated for seven days, the mobile phone may change to be inactivated after seven days from the initial setting. In other words, a user has to reset his or her mobile phone to be activated within seven days after the initial setting. In another example, a mobile phone is set to be in an activation status every Monday. Thus, a user has to reset his or her mobile phone to be activated no later than Monday after the initial setting. Otherwise, the mobile phone may be inactivated after Monday.

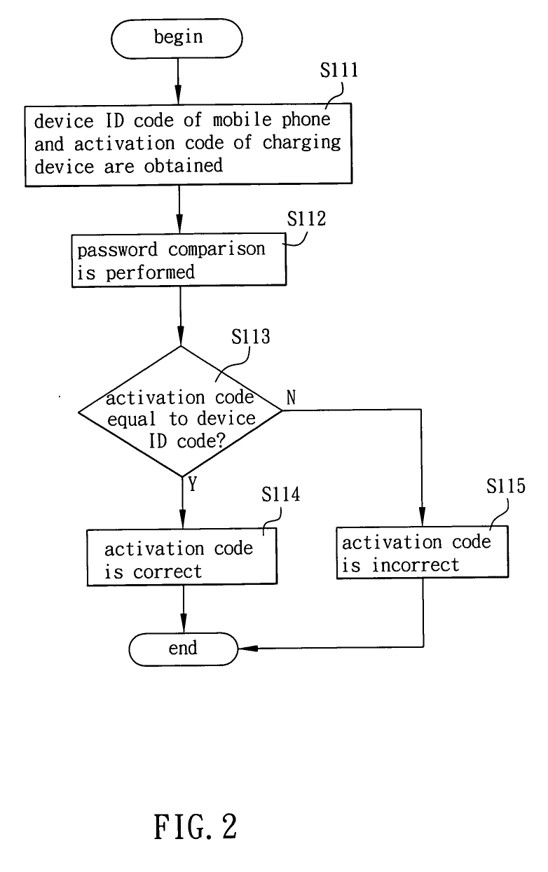

Referring to FIG. 2, the method for improving the security of a mobile communication device (e.g., mobile phone) with a feature that the mobile communication device is either activated or inactivated is illustrated. The preferred embodiment of the invention shows a verification process. The process comprises the following steps of obtaining a device identification code of a mobile phone and an activation code of a charging device S111, comparing the activation code with a device identification code of a mobile phone to generate a password S112, determining whether the activation code matches the device identification code according to the password S113, if the activation code matches the device identification code determining the activation code to be correct S114, and otherwise determining the activation code to be incorrect S115.

Note that the activation code is obtained by encrypting the device identification code. Also, the activation code is compared with the device identification code for determining whether they match up thereafter.

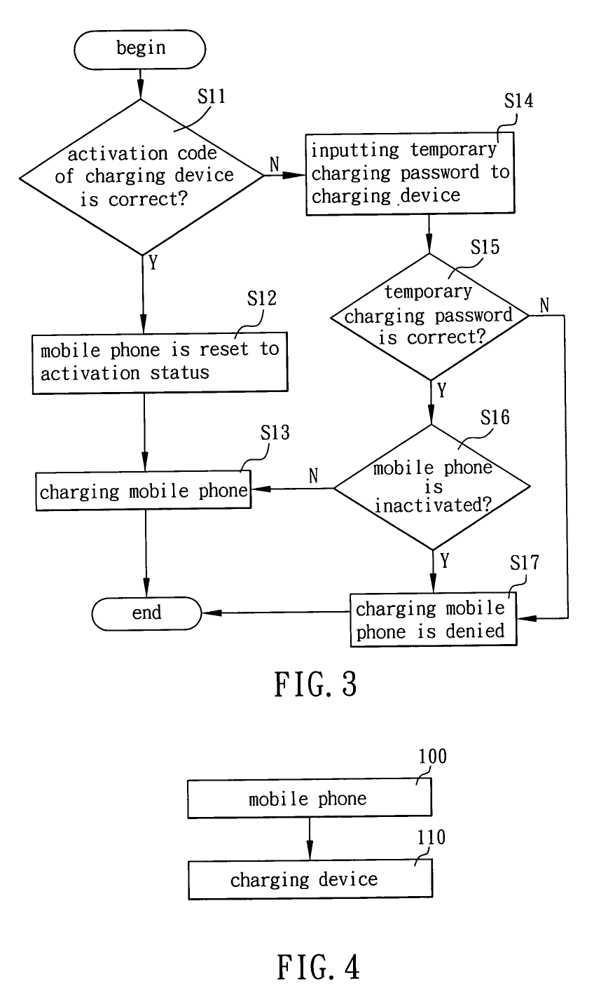

Referring to FIG. 3, the method for improving the security of a mobile communication device (e.g., mobile phone) with a feature that the mobile communication device is either activated or inactivated is illustrated. The preferred embodiment of the invention shows an activation and charging process. The process comprises the following steps of determining whether the activation code of the charging device is correct or not S11, setting the mobile phone to be activated S12 and charging the mobile communication device S13 if the activation code from the charging device is correct, and otherwise requiring inputting a temporary charging password to the charging device S14.

In the step S15, determining whether the temporary charging password is correct or not. If the temporary charging password is verified and the mobile communication device is activated, the mobile communication device is charged S16. If the temporary charging password is verified and the mobile communication device is not activated the mobile phone is denied to be charged S17.

Note that if the temporary charging password is unable to be verified upon the temporary charging password being input a predetermined number of times (e.g., three), the mobile communication device is locked and cannot perform certain functions until the mobile communication device is activated again with the number of times the temporary charging password is input re-counted.

Referring to FIG. 4, the connection between a prior mobile communication device (e.g., mobile phone) 100 and a charging device 110 is shown.

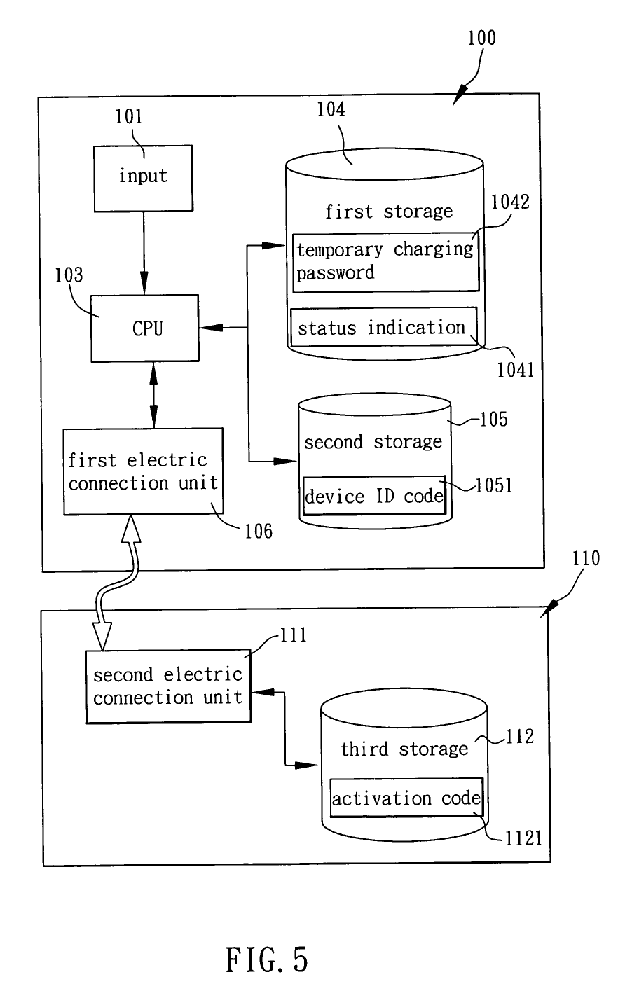

Referring to FIG. 5, a mobile communication device incorporating a security-improving mechanism according to another preferred embodiment of the invention shows the connection between the mobile communication device and the corresponding charging device wherein elements of this preferred embodiment having the same numerals indicate the similar elements of the above preferred embodiment. The mobile communication device incorporating the security-improving mechanism according to another preferred embodiment of the invention is generally designated by reference numeral 100. The mobile communication device 100 comprises a central processing unit 103 for determining if the mobile communication device is activated or not, a first electric connection unit 106 for transmitting and receiving electric signals and being served as a first charging port, an input device 101 for receiving input data, a first storage 104 for storing a status indication 1041 and a temporary charging password 1042, and a second storage 105 for storing a device identification code 1051 in order to determine if the activation code is valid or not. A charging device 110 for the mobile communication device 100 comprises a second electric connection unit 111 for transmitting and receiving electric signals and being served as a second charging port, and a third storage 112 for storing an activation code 1121 in order to perform the activation process.

The status indication 1041 in the first storage 104 can be labeled as either an activation status or an inactivation status by the central processing unit 103. The central processing unit 103 is capable of determining whether the status indication 1041 is activated or not. The central processing unit 103 may enable the mobile communication device 100 to be capable of performing certain functions if the status indication 1041 is labeled as an activation status. On the contrary, the central processing unit 103 may disable the mobile communication device 100 if the status indication 1041 is labeled as an inactivation status. In other words, the central processing unit 103 is required to perform an activation process in order to activate the mobile communication device 100. Accordingly, the mobile communication device 100 is capable of performing certain functions. The central processing unit 103 may enable the mobile communication device 100 to be shut down compulsively if the status indication 1041 is labeled as the inactivation status.

The status indication 1041 in the first storage 104 is not always labeled as an activation status. That is, the central processing unit 103 may label the status indication 1041 as an inactivation status over some duration. For example, if the status indication 1041 in a mobile phone is labeled as an activation status for seven days, it will be changed to be labeled as an inactivation status after seven days from the initial setting. In other words, a user has to reset the status indication 1041 in the mobile phone to be an activation status within seven days after the initial setting and then the seven-day counting is re-started.

In another example, the status indication 1041 in a mobile phone is set to be labeled as an activation status every Monday. Thus, a user has to reset the status indication 1041 in the mobile phone to be an activation status no later than Monday after the initial setting. Otherwise, the central processing unit 103 of the mobile phone may label the status indication 1041 as an inactivation status after Monday.

The activation process is performed by means of connecting the first electric connection unit 106 and the second electric connection unit 111, causing the central processing unit 103 of the mobile phone 100 to obtain an activation code 1121 stored in the third storage 112, causing the central processing unit 103 to determined whether the activation code 1121 is valid or not, labeling the status indication 1041 in the first storage 104 of the mobile communication device 100 as an activation status if the activation code 1121 is verified, and leaving the status indication 1041 in the first storage 104 unchanged if the activation code 1121 is not verified.

The activation process further comprises causing the central processing unit 103 to compare the activation code 1121 stored in the third storage 112 with the device identification code 1051 stored in the second storage 105 in order to determine whether the activation code is correct or not, and determining the activation code 1121 to be correct if the activation code 1121 matches the device identification code 1051 otherwise determining the activation code 1121 to be incorrect (i.e., the activation code 1121 does not match the device identification code 1051). The activation code 1121 is obtained by encrypting the device identification code 1051. Also, the activation code 1121 is compared with the device identification code 1051 in order to determine whether they match up or not.

Charging the mobile communication device 100 incorporating a security-improving mechanism according to another preferred embodiment of the invention is performed by means of connecting the first electric connection unit 106 and the second electric connection unit 111, causing the central processing unit 103 to enable the charging device 110 to charge the mobile communication device 100 if the activation code 1121 of the charging device 110 is valid, causing the central processing unit 103 to request a user to input a temporary charging password 1042 through the input device 101 if the activation code 1121 of the charging device 110 is not valid, charging the mobile communication device 100 if the temporary charging password 1042 is verified and the mobile communication device 100 is activated, and denying the mobile communication device 100 to be charged if either the temporary charging password 1042 is verified and the mobile communication device 100 is not activated or the temporary charging password 1042 is not verified.

The mobile communication device 100 is locked by the central processing unit 103 and incapable of performing certain functions until the mobile communication device 100 is activated again with the number of times the temporary charging password 1042 is input re-counted if the temporary charging password 1042 is unable to be verified upon the temporary charging password 1042 being input a predetermined number of times (e.g., three).

Both the second storage 105 and the third storage 112 can be ROM (Read-Only Memory) devices. That is, a unique device identification code 1051 is written in the second storage 105 in a manufacturing process of the second storage 105 and the third storage 112. Also, a corresponding activation code 1121 is generated by performing an encryption algorithm on the device identification code 1051. The activation code 1121 thus has a one-to-one corresponding relationship with the device identification code 1051. Next, the activation code 1121 is written in the third storage 112 such that the activation process can be performed only by cooperating with the charging device 110. In addition to the temporary charging process, the charging process is also required to be performed in cooperation with the charging device 110.

While the invention herein disclosed has been described by means of specific embodiments, numerous modifications and variations could be made thereto by those skilled in the art without departing from the scope and spirit of the invention set forth in the claims.

What is claimed is:

1. A method for improving security of a mobile communication device with a feature that if the mobile communication device is activated over some duration, the mobile communication device is then inactivated, comprising the steps of:
determining whether the mobile communication device is activated or not;
if the mobile communication device is activated, the mobile communication device being capable of performing certain functions; and
if the mobile communication device is not activated the mobile communication device being incapable of performing the functions until the mobile communication device is activated by an external device performing an activation process, thereafter the mobile communication device being capable of performing the functions again.

2. The method of claim 1, wherein the external device is a charging device.

3. The method of claim 1, wherein the mobile communication device is incapable of performing the functions in a way in which the mobile communication device is shut down compulsively if the mobile communication device is not activated.

4. The method of claim 2, wherein the activation process comprises the steps of:
obtaining an activation code from the charging device to be checked by a verification process;
activating the mobile communication device if the activation code is verified; and
remaining the mobile communication device not to be activated if the activation code is not verified.

5. The method of claim 4, wherein the verification process further comprises the steps of:
comparing the activation code with a device identification code of the mobile communication device;
determining that the activation code is correct if the activation code matches the device identification code; and
determining that the activation code is incorrect if the activation code does not match the device identification code.

6. The method of claim 5, further comprising the steps of:
charging the mobile communication device if the activation code from the charging device is correct; and
denying the mobile communication device to be charged if the activation code from the charging device is incorrect.

7. The method of claim 6, further comprising the steps of;
requiring inputting a temporary charging password to the charging device if the activation code from the charging device is incorrect;
charging the mobile communication device if the temporary charging password is verified and the mobile communication device is activated; and
denying the mobile communication device to be charged if the temporary charging password is verified and the mobile communication device is not activated.

8. The method of claim 7, wherein if the temporary charging password is unable to be verified upon the temporary charging password being input a predetermined number of times, the mobile communication device is locked until the mobile communication device is activated again with the number of times the temporary charging password is input re-counted.

9. A mobile communication device with a feature that if the mobile communication device is activated over some duration, the mobile communication device is then inactivated, comprising:
a central processing unit for determining if the mobile communication device is activated or not;
a first storage for storing a status indication a first electric connection unit for being served as a first charging port;
a second electric connection unit for being served as a second charging port; and
an external device for performing an activation process to activate the mobile communication device;
wherein if the mobile communication device is activated, the mobile communication device is capable of performing certain functions by the central processing unit; and if the mobile communication device is not activated, the mobile communication device is incapable of performing the functions until the mobile communication device is activated by the external device performing the activation process, and thereafter the mobile communication device is capable of performing the functions again.

10. The mobile communication device of claim 9, wherein the external device is a charging device.

11. The mobile communication device of claim 9, wherein the status indication is labeled as an activation status if the mobile communication device is activated otherwise the status indication is labeled as an inactivation status.

12. The mobile communication device of claim 11, wherein the mobile communication device is shut down compulsively by the central processing unit if the status indication is labeled as the inactivation status.

13. The mobile communication device of claim 10, wherein the charging device further comprises a third storage for storing an activation code which is obtained after the first electric connection unit is connected to the second electric connection unit in order to perform the activation process.

14. The mobile communication device of claim 13, further comprising a second storage for storing a device identification code in order to determine if the activation code is valid or not.

15. The mobile communication device of claim 14, wherein the central processing unit enables the charging device to charge the mobile communication device if the activation code is valid otherwise the central processing unit disables the charging device to charge the mobile communication device.

16. The mobile communication device of claim 15, further comprising an input device for receiving a temporary charging password input by a user in order to charge the mobile communication device when the activation code is not valid.

17. The mobile communication device of claim 16 wherein if the temporary charging password is unable to be verified upon the temporary charging password being input a predetermined number of times, the mobile communication device is locked by the central processing unit until the mobile communication device is activated again with the number of times the temporary charging password is input re-counted.

18. The mobile communication device of claim 13, wherein the third storage is a ROM (Read-Only Memory) device.

19. The mobile communication device of claim 14, wherein the second storage is a ROM device.
